(19) United States
(12) Patent Application Publication
(10) Pub. No.: US 2024/0061599 A1
(43) Pub. Date: Feb. 22, 2024

(54) METHOD AND SYSTEM FOR PROCESSING FILE READ-WRITE SERVICE, DEVICE, AND MEDIUM

(71) Applicant: INSPUR SUZHOU INTELLIGENT TECHNOLOGY CO.,LTD., Jiangsu (CN)

(72) Inventors: Shuaiyang WANG, Shandong (CN); Wenpeng LI, Shandong (CN); Xudong LI, Shandong (CN)

(73) Assignee: INSPUR SUZHOU INTELLIGENT TECHNOLOGY CO.,LTD., Jiangsu (CN)

(21) Appl. No.: 18/270,457

(22) PCT Filed: Sep. 29, 2021
(86) PCT No.: PCT/CN2021/121898

§ 371 Date: Jun. 29, 2023

(30) Foreign Application Priority Data
Jul. 28, 2021 (CN) 202110853962.1

(51) Int. Cl. G06F 3/06; G06F 16/172

(52) U.S. Cl. CPC G06F 3/0643; G06F 3/0604; G06F 3/0673; G06F 16/172

(57) ABSTRACT

The present application discloses a method for processing a file read-write service. The method includes: in response to receiving a read-write service of a file, determining, based on a file serial number, whether a cache handle of the file is present in an index container; in response to the cache handle of the file not being present in the index container, opening, based on the read-write service, a corresponding handle of the file; encapsulating a flag and a pointer of the corresponding handle and the file serial number so as to obtain a cache handle of the file; adding the cache handle of the file into the index container and a first queue; processing the read-write service by using the corresponding handle of the file; and in response to completion of processing the read-write service, moving the cache handle of the file from the first queue to a second queue.

### CROSS-REFERENCE TO RELATED APPLICATION

This application is a National Stage Application of International Application No. PCT/CN2021/121898, filed 29 Sep. 2021, which claims the benefit of Serial No. 202110853962.1 filed on Jul. 28, 2021 in China, and which applications are incorporated herein by reference. To the extent appropriate, a claim of priority is made to each of the above disclosed applications.

### TECHNICAL FIELD

The present application relates to the field of storage, in particular to a method and system for processing a file read-write service, a device, and a storage medium.

### BACKGROUND

For a distributed file system (object storage), since an HDFS protocol access is a stateless access (a client does not send open and close requests to a storage end as the standard posix protocol does), the distributed file system needs to open a file handle each time it receives a read-write request to implement a read-write service, and then close the file handle after completing the service. As a result, a large number of requests for opening and closing file handles are caused, which causes a large load on the system and increases the delay of each read-write IO.

### SUMMARY

Embodiments of the present application provide a method for processing a file read-write service. The method includes the following steps:
in response to receiving a read-write service of a file, determining, based on a file serial number, whether a cache handle of the file is present in an index container;
in response to the cache handle of the file not being present in the index container, opening, based on the read-write service, a corresponding handle of the file;
encapsulating a flag and a pointer of the corresponding handle and the file serial number so as to obtain a cache handle of the file;
adding the cache handle of the file into the index container and a first queue;
processing the read-write service by using the corresponding handle of the file; and
in response to completion of processing the read-write service, moving the cache handle of the file from the first queue to a second queue.

In some embodiments of the present application, the method further includes:
detecting a usage time of each of cache handles in the second queue to determine whether the usage time exceeds a threshold;
in response to a presence of a cache handle with usage time exceeding the threshold, removing the cache handle with the usage time exceeding the threshold from the second queue; and
removing a corresponding cache handle in the index container based on a file serial number in the cache handle with the usage time exceeding the threshold, and closing a corresponding handle based on a handle pointer.

In some embodiments of the present application, the method further includes:
in response to a quantity of cache handles in the second queue reaching a preset quantity, deleting a plurality of cache handles starting from a tail of the second queue; and
deleting corresponding cache handles in the index container based on file serial numbers in the plurality of cache handles respectively, and closing corresponding handles based on handle pointers.

In some embodiments of the present application, the method further includes:
in response to the cache handle of the file being present in the index container, determining whether a handle flag in the cache handle of the file corresponds to the read-write service; and
in response to the handle flag in the cache handle of the file corresponding to the read-write service and the cache handle of the file being in the second queue, moving the cache handle in the second queue to the first queue, and processing the read-write service by using an opened corresponding handle of the file.

In some embodiments of the present application, the method further includes:
in response to the handle flag in the cache handle of the file corresponding to the read-write service and the cache handle of the file being in the first queue, processing the read-write service by using the opened corresponding handle of the file, and updating a usage count of the cache handle of the file.

In some embodiments of the present application, moving the cache handle of the file from the first queue to the second queue further includes:
determining whether the usage count of the cache handle of the file reaches a preset value;
in response to the usage count of the cache handle of the file reaching the preset value, moving the cache handle of the file to a head of the second queue; and
updating the usage time of the cache handle of the file.

In some embodiments of the present application, the method further includes:
in response to the handle flag in the cache handle of the file not corresponding to the read-write service and the cache handle of the file being in the second queue, deleting the cache handle of the file from the second queue and the index container, and closing the corresponding handle based on the handle pointer;
reopening the corresponding handle of the file based on the read-write service;
encapsulating the flag and the pointer of the corresponding handle and the file serial number so as to obtain a new cache handle of the file;
adding the new cache handle of the file into the index container and the first queue; and
processing the read-write service by using a reopened corresponding handle of the file.

Based on the same inventive concept, according to another aspect of the present application, an embodiment of the present application further provides a system for processing a file read-write service. The system includes:
a determining component, configured to determine, in response to receiving a read-write service of a file and based on a file serial number, whether a cache handle of the file is present in an index container;
an opening component, configured to open, in response to the cache handle of the file not being present in the index container and based on the read-write service, a corresponding handle of the file;
an encapsulating component, configured to encapsulate a flag and a pointer of the corresponding handle and the file serial number so as to obtain a cache handle of the file;
a cache component, configured to add the cache handle of the file into the index container and a first queue;
a processing component, configured to process the read-write service by using the corresponding handle of the file; and
a moving component, configured to move, in response to completion of processing the read-write service, the cache handle of the file from the first queue to a second queue.

Based on the same inventive concept, according to still another aspect of the present application, an embodiment of the present application further provides a computer device. The computer device includes:
at least one processor; and
a memory having stored thereon a computer program capable of running on the processor. The processor, when executing the program, performs the steps of any one of the above methods for processing the file read-write service.

Based on the same inventive concept, according to yet still another aspect of the present application, an embodiment of the present application further provides a non-transitory computer-readable storage medium. The non-transitory computer-readable storage medium has a computer program stored thereon, and the computer program, when executed by a processor, performs the steps of any one of the above methods for processing the file read-write service.

### BRIEF DESCRIPTION OF THE DRAWINGS

In order to more clearly describe the technical solutions of the embodiments of the present application or in the prior art, drawings that are to be referred for description of the embodiments or the prior art will be briefly described hereinafter. Apparently, the drawings described hereinafter merely illustrate some embodiments of the present application, and a person of ordinary skill in the art may also derive other embodiments based on the drawings described herein without any creative effort.

FIG. 1 is a schematic flow diagram of a method for processing a file read-write service according to an embodiment of the present application.

FIG. 2 is a schematic structural diagram of a system for processing a file read-write service according to an embodiment of the present application.

FIG. 3 is a schematic structural diagram of a computer device according to an embodiment of the present application.

FIG. 4 is a schematic structural diagram of a non-transitory computer-readable storage medium according to an embodiment of the present application.

### DETAILED DESCRIPTION OF THE EMBODIMENTS

In order to make the objects, technical solutions, and advantages of the present application more clear, embodiments of the present application are further described in detail below with reference to embodiments and the accompanying drawings.

It is to be noted that all expressions using “first” and “second” in the embodiments of the present application are intended to distinguish two different entities or parameters with the same name. It may be seen that “first” and “second” are merely for the convenience of expressions and should not be construed as limiting the embodiments of the present application, which will not be stated one by one in subsequent embodiments.

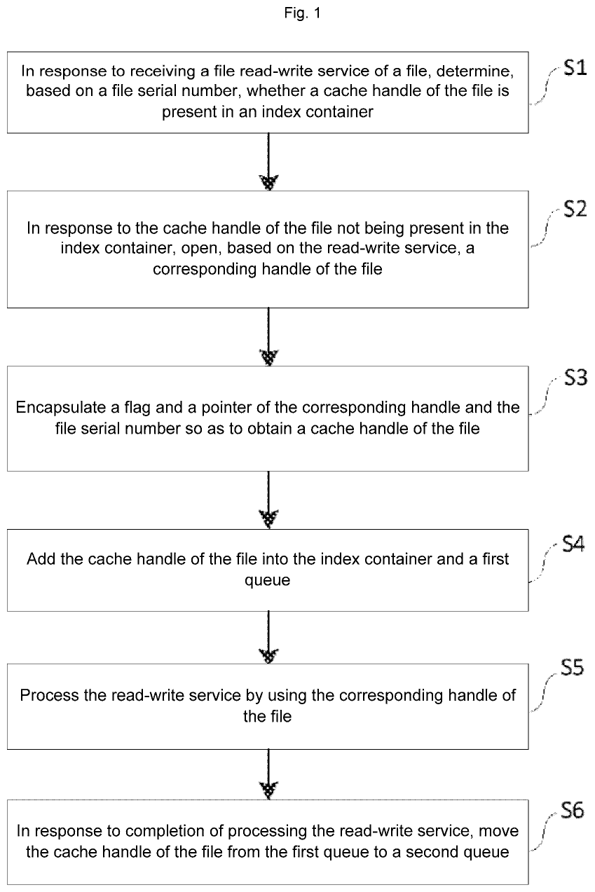

According to one aspect of the present application, an embodiment of the present application provides a method for processing a file read-write service. As shown in FIG. 1, the method may include the following steps:
S1: In response to receiving a read-write service of a file, it is determined, based on a file serial number, whether a cache handle of the file is present in an index container.
S2: In response to the cache handle of the file not being present in the index container, a corresponding handle of the file is opened, based on the read-write service.
S3: A flag and a pointer of the corresponding handle and the file serial number are encapsulated so as to obtain a cache handle of the file.
S4: The cache handle of the file is added into the index container and a first queue.
S5: The read-write service is processed by using the corresponding handle of the file.
S6: In response to completion of processing the read-write service, the cache handle of the file is moved from the first queue to a second queue.

In some embodiments of the present application, in step S1, in response to receiving the read-write service of the file, whether the cache handle of the file is present in the index container is determined based on the file serial number. The index container may be a standard template library (STL), such that, after the cache handle of the file is added into the index container, the corresponding cache handle may be searched for and determined based on the file serial number.

In some embodiments of the present application, when the read-write service of the file is received, firstly, the index container may be searched based on the file serial number (for example, the ino number of the file) to determine whether the cache handle is cached in the index container. In response to that the cache handle is not cached in the index container, it means that the handle of the file is not opened, and then corresponding handles of a distributed file system need to be opened based on the read-write service, that is, a read service opens a read handle, and a write service opens a write handle. Then, the flag and the pointer of the handle of the file and the file serial number are encapsulated to obtain the cache handle of the file, and the cache handle is saved to the index container and the first queue. Next, the read-write service may be implemented by using the opened handle. Finally, after the read-write service is completed, the cache handle is moved from the first queue to the second queue.

Thus, when the cache handle is present in the first queue, determining the cache handle is being used to perform the read-write service, and when the cache handle is present in the second queue, determining the cache handle is not used.

By means of the solutions provided in the embodiments of the present application, the index container is used for quick query mapping of files to handles, the first queue is used for handle protection, and the second queue is used for efficient detection of invalid handles, such that file handle processing pressure and frequency during reading and writing by the distributed file system are effectively reduced, and then the file read-write delay of read-write 10 is reduced.

In some embodiments of the present application, the method further includes:
detect a usage time of each of cache handles in the second queue to determine whether the usage time exceeds a threshold;
in response to a presence of a cache handle with usage time exceeding the threshold, remove the cache handle with the usage time exceeding the threshold from the second queue; and
remove a corresponding cache handle in the index container based on a file serial number in the cache handle with the usage time exceeding the threshold, and close a corresponding handle based on a handle pointer.

When the cache handle is present in the second queue, it means that the corresponding handle is not used, such that the usage time of each cache handle in the second queue may be set, and a time threshold is set. The usage time is updated when the cache handle is moved from the first queue to the second queue. In response to that the usage time of a cache handle in the second queue has not been updated for a long time, that is, the usage time exceeds a set time threshold, the cache handle in the second queue may be removed, and the same cache handle in the index container is found based on the file serial number, and deleted. Finally, the corresponding handle in the distributed file system is closed based on the handle pointer.

In some embodiments of the present application, the method further includes:
delete, in response to a quantity of cache handles in the second queue reaching a preset quantity, a plurality of cache handles starting from a tail of the second queue; and
delete corresponding cache handles in the index container based on file serial numbers in the plurality of cache handles respectively, and close corresponding handles based on handle pointers.

The quantity of the cache handles in the second queue may be limited, and when the quantity of the cache handles in the second queue reaches the preset quantity, a plurality of cache handles may be deleted starting from the tail of the second queue. Similarly, the cache handles in the second queue may be removed firstly, then the same cache handles in the index container are found based on the file serial numbers, and deleted, and finally, the corresponding handles in the distributed file system are closed based on the handle pointers.

It is to be noted that when the cache handle is moved from the first queue to the second queue, the cache handle may be placed at a head of the second queue, such that the tail of the second queue is a cache handle with a relatively long time. Therefore, when the quantity of the cache handles in the second queue exceeds the threshold, the cache handles may be removed starting from the tail of the second queue.

In some embodiments of the present application, the method further includes:
determine, in response to the cache handle of the file being present in the index container, whether a handle flag in the cache handle of the file corresponds to the read-write service; and
in response to the handle flag in the cache handle of the file corresponding to the read-write service and the cache handle of the file being in the second queue, move the cache handle in the second queue to the first queue, and process the read-write service by using an opened corresponding handle of the file.

When the read-write service of the file is received, the corresponding cache handle may be found in the index container based on the file serial number, and whether the handle flag in the cache handle corresponds to the read-write service needs to be determined, that is, handle flag detection is performed. Due to the read-write difference, different flags are required for IO. For write operations, rw flags are required, and for read operations, r flags are required. In response to that the cache handle does not include a required flag, a file handle needs to be reopened based on a flag required by the read-write service.

Therefore, in response to that the handle flag in the cache handle of the file corresponds to the read-write service and the cache handle of the file is in the second queue, the cache handle in the second queue is moved to the first queue, and the read-write service is processed by using the opened corresponding handle of the file.

In some embodiments of the present application, the method further includes:
in response to the handle flag in the cache handle of the file corresponding to the read-write service and the cache handle of the file being in the first queue, process the read-write service by using the opened corresponding handle of the file, and update a usage count of the cache handle of the file.

In response to that the handle flag in the cache handle of the file corresponds to the read-write service and the cache handle of the file is in the first queue, it means that another thread is using the corresponding handle at this moment. Therefore, the usage count may be set, and when another thread uses the opened corresponding handle of the file for the read-write service, the usage count of the cache handle of the file may be increased. When the read-write service of a thread is completed, the usage count of the cache handle of the file may be decreased.

In some embodiments of the present application, the method further includes:
in response to the handle flag in the cache handle of the file not corresponding to the read-write service and the cache handle of the file being in the second queue, delete the cache handle of the file from the second queue and the index container, and close the corresponding handle based on the handle pointer;
reopen the corresponding handle of the file based on the read-write service;
encapsulate the flag and the pointer of the corresponding handle and the file serial number so as to obtain a new cache handle of the file;
add the new cache handle of the file into the index container and the first queue; and
process the read-write service by using a reopened corresponding handle of the file.

In response to that the handle flag in the cache handle of the file does not correspond to the read-write service, a handle needs to be reopened. In this case, in response to that the cache handle of the file is in the second queue, it means that no thread is using the current handle, such that the cache handle may be directly removed from the second queue and the index container. Then, the corresponding handle is closed based on the handle pointer, then the corresponding handle of the file is reopened according to the read-write service, the flag and the pointer of the corresponding handle and the file serial number are encapsulated to obtain a new cache handle of the file, and the new cache handle is saved to the first queue and the index container.

In some embodiments of the present application, moving the cache handle of the file from the first queue to the second queue further includes:
determine whether the usage count of the cache handle of the file reaches a preset value;
in response to the usage count of the cache handle of the file reaching the preset value, move the cache handle of the file to a head of the second queue; and
update the usage time of the cache handle of the file.

When the usage count is 0, it means that no thread is using the handle at this time, such that the corresponding cache handle may be moved to the second queue, and the usage time of the cache handle is updated.

By means of the solutions provided in the embodiments of the present application, the index container is used for quick query mapping of files to handles, the first queue is used for handle protection, and the second queue is used for efficient detection of invalid handles, such that file handle processing pressure and frequency during reading and writing by a distributed file system are effectively reduced, and then the file read-write delay of read-write 10 is reduced.

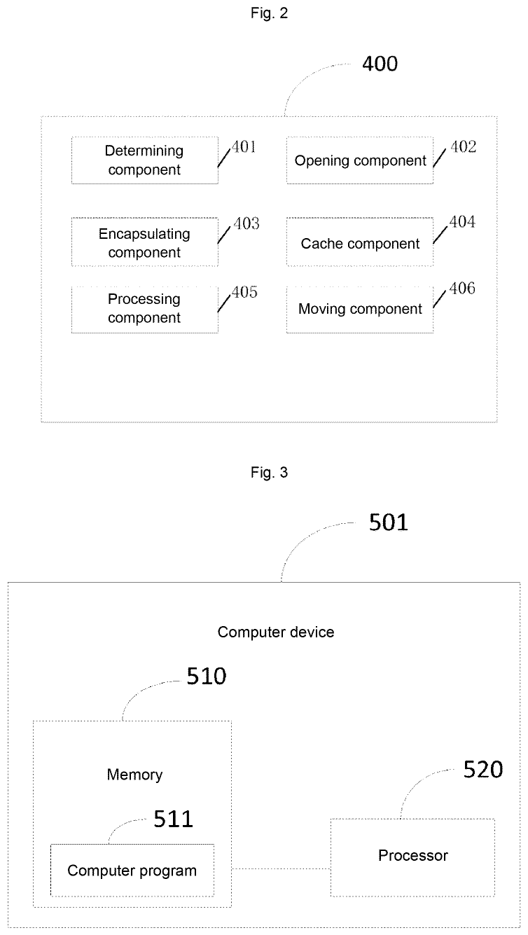

Based on the same inventive concept, according to another aspect of the present application, an embodiment of the present application further provides a system 400 for processing a file read-write service. As shown in FIG. 2, the system includes:
a determining component 401, configured to determine, in response to receiving a read-write service of a file and based on a file serial number, whether a cache handle of the file is present in an index container;
an opening component 402, configured to open, in response to the cache handle of the file not being present in the index container and based on the read-write service, a corresponding handle of the file;
an encapsulating component 403, configured to encapsulate a flag and a pointer of the corresponding handle and the file serial number so as to obtain a cache handle of the file;
a cache component 404, configured to add the cache handle of the file into the index container and a first queue;
a processing component 405, configured to process the read-write service by using the corresponding handle of the file; and
a moving component 406, configured to move, in response to completion of processing the read-write service, the cache handle of the file from the first queue to a second queue.

In some embodiments of the present application, the system further includes:
detect a usage time of each of cache handles in the second queue to determine whether the usage time exceeds a threshold;
in response to a presence of a cache handle with usage time exceeding the threshold, remove the cache handle with the usage time exceeding the threshold from the second queue; and
remove a corresponding cache handle in the index container based on a file serial number in the cache handle with the usage time exceeding the threshold, and close a corresponding handle based on a handle pointer.

In some embodiments of the present application, the system further includes:
delete, in response to a quantity of cache handles in the second queue reaching a preset quantity, a plurality of cache handles starting from a tail of the second queue; and
delete corresponding cache handles in the index container based on file serial numbers in the plurality of cache handles respectively, and close corresponding handles based on handle pointers.

In some embodiments of the present application, the system further includes:
determine, in response to the cache handle of the file being present in the index container, whether a handle flag in the cache handle of the file corresponds to the read-write service; and
in response to the handle flag in the cache handle of the file corresponding to the read-write service and the cache handle of the file being in the second queue, move the cache handle in the second queue to the first queue, and process the read-write service by using an opened corresponding handle of the file.

In some embodiments of the present application, the system further includes:
in response to the handle flag in the cache handle of the file corresponding to the read-write service and the cache handle of the file being in the first queue, process the read-write service by using the opened corresponding handle of the file, and update a usage count of the cache handle of the file.

In some embodiments of the present application, moving the cache handle of the file from the first queue to the second queue further includes:
determine whether the usage count of the cache handle of the file reaches a preset value;
in response to the usage count of the cache handle of the file reaching the preset value, move the cache handle of the file to a head of the second queue; and
update the usage time of the cache handle of the file.

In some embodiments of the present application, the system further includes:
in response to the handle flag in the cache handle of the file not corresponding to the read-write service and the cache handle of the file being in the second queue, delete the cache handle of the file from the second queue and the index container, and close the corresponding handle based on the handle pointer;
reopen the corresponding handle of the file based on the read-write service;
encapsulate the flag and the pointer of the corresponding handle and the file serial number so as to obtain a new cache handle of the file;
add the new cache handle of the file into the index container and the first queue; and
process the read-write service by using a reopened corresponding handle of the file.

By means of the solutions provided in the embodiments of the present application, the index container is used for quick query mapping of files to handles, the first queue is used for handle protection, and the second queue is used for efficient detection of invalid handles, such that file handle processing pressure and frequency during reading and writing by a distributed file system are effectively reduced, and then the file read-write delay of read-write 10 is reduced.

Based on the same inventive concept, according to still another aspect of the present application, as shown in FIG. 3, an embodiment of the present application further provides a computer device 501. The computer device includes:
at least one processor 520; and
a memory 510, the memory 510 having stored thereon a computer program 511 capable of running on the processor. The processor 520, when executing the program, performs the following steps:
S1: In response to receiving a read-write service of a file, it is determined, based on a file serial number, whether a cache handle of the file is present in an index container.
S2: In response to the cache handle of the file not being present in the index container, a corresponding handle of the file is opened, based on the read-write service.
S3: A flag and a pointer of the corresponding handle and the file serial number are encapsulated so as to obtain a cache handle of the file.
S4: The cache handle of the file is added into the index container and a first queue.
S5: The read-write service is processed by using the corresponding handle of the file.
S6: In response to completion of processing the read-write service, the cache handle of the file is moved from the first queue to a second queue.

In some embodiments of the present application, the following steps are further included:
detect a usage time of each of cache handles in the second queue to determine whether the usage time exceeds a threshold;
in response to a presence of a cache handle with usage time exceeding the threshold, remove the cache handle with the usage time exceeding the threshold from the second queue; and
remove a corresponding cache handle in the index container based on a file serial number in the cache handle with the usage time exceeding the threshold, and close a corresponding handle based on a handle pointer.

In some embodiments of the present application, the following steps are further included:
delete, in response to a quantity of cache handles in the second queue reaching a preset quantity, a plurality of cache handles starting from a tail of the second queue; and
delete corresponding cache handles in the index container based on file serial numbers in the plurality of cache handles respectively, and close corresponding handles based on handle pointers.

In some embodiments of the present application, the following steps are further included:
determine, in response to the cache handle of the file being present in the index container, whether a handle flag in the cache handle of the file corresponds to the read-write service; and
in response to the handle flag in the cache handle of the file corresponding to the read-write service and the cache handle of the file being in the second queue, move the cache handle in the second queue to the first queue, and process the read-write service by using an opened corresponding handle of the file.

In some embodiments of the present application, the following step is further included:
in response to the handle flag in the cache handle of the file corresponding to the read-write service and the cache handle of the file being in the first queue, process the read-write service by using the opened corresponding handle of the file, and update a usage count of the cache handle of the file.

In some embodiments of the present application, moving the cache handle of the file from the first queue to the second queue further includes:
determine whether the usage count of the cache handle of the file reaches a preset value;
in response to the usage count of the cache handle of the file reaching the preset value, move the cache handle of the file to a head of the second queue; and
update the usage time of the cache handle of the file.

In some embodiments of the present application, the following steps are further included:
in response to the handle flag in the cache handle of the file not corresponding to the read-write service and the cache handle of the file being in the second queue, delete the cache handle of the file from the second queue and the index container, and close the corresponding handle based on the handle pointer:
reopen the corresponding handle of the file based on the read-write service;
encapsulate the flag and the pointer of the corresponding handle and the file serial number so as to obtain a new cache handle of the file;
add the new cache handle of the file into the index container and the first queue; and
process the read-write service by using a reopened corresponding handle of the file.

By means of the solutions provided in the embodiments of the present application, the index container is used for quick query mapping of files to handles, the first queue is used for handle protection, and the second queue is used for efficient detection of invalid handles, such that file handle processing pressure and frequency during reading and writing by a distributed file system are effectively reduced, and then the file read-write delay of read-write 10 is reduced.

The processor 520 may include one or more processing cores, such as a 4-core processor, an 8-core processor, and the processor 520 may also be a controller, microcontroller, microprocessor or other data processing chip, etc. The processor 520 may be implemented in at least one hardware form of Digital Signal Processing (DSP), a Field-Programmable Gate Array (FPGA), and Programmable Logic Array (PLA), The processor 520 may also include a main processor and a coprocessor. The main processor is a processor configured to process data in a wake state, also known as a Central Processing Unit (CPU), and the coprocessor is a low-power processor configured to process data in a standby state. In some embodiments of the present disclosure, the processor 520 may be integrated with a Graphics Processing Unit (GPU), and the GPU is responsible for rendering and drawing the content that a display screen needs to display. In some embodiments of the present disclosure, the processor 520 may also include an Artificial intelligence (AI) processor: and the AI processor is configured to process computational operations related to machine learning.

The memory 510 may include one or more non-transitory computer-readable storage medium, which may be non-transient. The memory 510 may include a high speed Random Access Memory (RAM) and a non-volatile memory such as one or more disk storage apparatuses and a flash memory. In some embodiments of the present disclosure, the memory 510 may be an internal storage unit of the electronic device, such as a hard disk of a server. In other embodiments of the present disclosure, the memory 510 may also be an external storage device of the electronic device, such as a plug-in hard disk, a Smart Media Card (SMC), a Secure Digital Card (SD), a Flash Card, etc., equipped on the server. Further, the memory 510 may include both the internal storage unit of the computer device and the external storage device. The memory 510 may be configured not only to store application software and various data installed in the electronic device, such as a code of a program that performs a vulnerability handling method, but also to temporarily store data that has been or will be output. In some embodiments of the present disclosure, the memory 510 is configured to store at least the following computer program 511. The computer program, after being loaded and executed by processor 520, is capable of implementing the relevant steps of the method for processing a file read-write service disclosed in any of the foregoing embodiments. In addition, resources stored by the memory 510 may also include an operating system and data, etc., and a storage method may be transient storage or permanent storage. The operating system may include Windows, Unix, Linux, etc.

In some embodiments of the present disclosure, the computer device may also include a display screen, an input-output interface, a communication interface or a network interface, a power supply, and a communication bus. The display screen and the input-output interface, such as a Keyboard, are user interfaces, and the user interfaces may also include standard wired interfaces, wireless interfaces, etc. In some embodiments of the present disclosure, the display may be a Light-Emitting Diode (LED) display, a liquid crystal display, a touch liquid crystal display, an Organic Light-Emitting Diode (OLED) touch device, etc. The display, which may also be appropriately referred to as a display screen or display unit, is configured to display information processed in the electronic device and a user interface for display visualization. In some embodiments of the present disclosure, the communication interface may include wired interfaces and/or wireless interfaces, such as WI-FI interfaces, Bluetooth interfaces, etc., which are commonly configured to establish communication connections between the electronic device and other electronic devices. The communication bus may be either a Peripheral Component Interconnect (PCI) bus or an Extended Industry Standard Architecture (EISA) bus, etc. The bus may be classified into an address bus, a data bus, a control bus, etc.

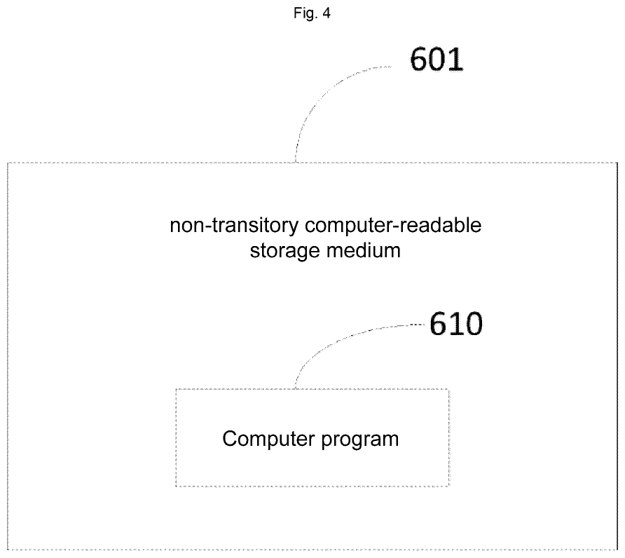

Based on the same inventive concept, according to yet still another aspect of the present application, as shown in FIG. 4, an embodiment of the present application further provides a non-transitory computer-readable storage medium 601. The non-transitory computer-readable storage medium 601 has a computer program 610 stored thereon. The computer program 610, when executed by a processor, performs the following steps:
S1: In response to receiving a read-write service of a file, it is determined, based on a file serial number, whether a cache handle of the file is present in an index container.
S2: In response to the cache handle of the file not being present in the index container, a corresponding handle of the file is opened, based on the read-write service.
S3: A flag and a pointer of the corresponding handle and the file serial number are encapsulated so as to obtain a cache handle of the file.
S4: The cache handle of the file is added into the index container and a first queue.
S5: The read-write service is processed by using the corresponding handle of the file.
S6: In response to completion of processing the read-write service, the cache handle of the file is moved from the first queue to a second queue.

In some embodiments of the present application, the following steps are further included:
detect a usage time of each of cache handles in the second queue to determine whether the usage time exceeds a threshold;
in response to a presence of a cache handle with usage time exceeding the threshold, remove the cache handle with the usage time exceeding the threshold from the second queue; and
remove a corresponding cache handle in the index container based on a file serial number in the cache handle with the usage time exceeding the threshold, and close a corresponding handle based on a handle pointer.

In some embodiments of the present application, the following steps are further included:
delete, in response to a quantity of cache handles in the second queue reaching a preset quantity, a plurality of cache handles starting from a tail of the second queue; and
delete corresponding cache handles in the index container based on file serial numbers in the plurality of cache handles respectively, and close corresponding handles based on handle pointers.

In some embodiments of the present application, the following steps are further included:
determine, in response to the cache handle of the file being present in the index container, whether a handle flag in the cache handle of the file corresponds to the read-write service; and
in response to the handle flag in the cache handle of the file corresponding to the read-write service and the cache handle of the file being in the second queue, move the cache handle in the second queue to the first queue, and process the read-write service by using an opened corresponding handle of the file.

In some embodiments of the present application, the following step is further included:
in response to the handle flag in the cache handle of the file corresponding to the read-write service and the cache handle of the file being in the first queue, process the read-write service by using the opened corresponding handle of the file, and update a usage count of the cache handle of the file.

In some embodiments of the present application, moving the cache handle of the file from the first queue to a second queue further includes:
determine whether the usage count of the cache handle of the file reaches a preset value;
in response to the usage count of the cache handle of the file reaching the preset value, move the cache handle of the file to a head of the second queue; and
update the usage time of the cache handle of the file.

In some embodiments of the present application, the following steps are further included:
in response to the handle flag in the cache handle of the file not corresponding to the read-write service and the cache handle of the file being in the second queue, delete the cache handle of the file from the second queue and the index container, and close the corresponding handle based on the handle pointer;
reopen the corresponding handle of the file based on the read-write service;
encapsulate the flag and the pointer of the corresponding handle and the file serial number so as to obtain a new cache handle of the file;
add the new cache handle of the file into the index container and the first queue; and
process the read-write service by using a reopened corresponding handle of the file.

By means of the solutions provided in the embodiments of the present application, the index container is used for quick query mapping of files to handles, the first queue is used for handle protection, and the second queue is used for efficient detection of invalid handles, such that file handle processing pressure and frequency during reading and writing by a distributed file system are effectively reduced, and then the file read-write delay of read-write 10 is reduced.

Finally, it is to be noted that a person of ordinary skill in the art may appreciate that all or part of the flow of the above method embodiment may be implemented by a computer program instructing associated hardware. The program may be stored on a non-transitory computer-readable storage medium, and, when executed, may include the flow of the above method embodiments.

In addition, it should be understood that the non-transitory computer-readable storage medium (for example, a memory) herein may be a volatile memory or a non-volatile memory, or may include both a volatile memory and a non-volatile memory.

The non-transitory computer-readable storage medium includes: various media capable of storing program codes such as a U disk, a mobile hard disk, a Read-Only Memory (ROM), an RAM, an electrically erasable programmable ROM, a register, a hard disk, a multimedia card, a card type memory (such as an SD or DX memory, etc.), a magnetic memory, a removable disk, a CD-ROM, a magnetic disk, or an optical disk.

It will also be appreciated by a person skilled in the art that the various exemplary logic blocks, components, circuits, and algorithmic steps described in conjunction with the disclosure herein may be implemented as electronic hardware, computer software, or a combination of both. In order to clearly illustrate such interchangeability of hardware and software, a general description of the various illustrative components, blocks, components, circuits, and steps has been provided with respect to their functionality. Whether such functionality is implemented as software or as hardware depends on the specific application and the design constraints imposed on the overall system. The functionality may be implemented in various ways by a person skilled in the art for each specific application, but such implementation decisions should not be construed to cause a departure from the scope of the disclosure of the embodiments of the present application.

The above are exemplary embodiments of the present application, but it should be noted that various changes and modifications may be made without deviating from the scope of disclosure of the embodiments of the present application as defined by the appended claims. The functions, steps, and/or actions of the method claims in accordance with the disclosed embodiments described herein need not be performed in any particular order. Furthermore, although elements according to the embodiments of the present application may be described or claimed in the singular, the plural is contemplated unless limitation to the singular is explicitly stated.

It should be understood that, as used herein, the singular forms “a”, “an”, and “the” are intended to include the plural forms as well, unless the context clearly supports the exception. It should also be understood that the term “and/or” as used herein refers to any or all possible combinations including one or more associated listed items.

The serial number of the embodiments of the present application is disclosed for description merely and does not represent the merits of the embodiments.

A person of ordinary skill in the art may appreciate that all or part of the steps of implementing the above embodiments may be completed by hardware, or may be completed by a program instructing relevant hardware. The program may be stored in a non-transitory computer-readable storage medium which may be a read-only memory, a magnetic disk or a compact disk, etc.

A person of ordinary skill in the art may appreciate that the above discussion of any embodiments is intended to be exemplary only, and is not intended to suggest that the scope (including the claims) of the embodiments of the present application is limited to these examples; and combinations of features in the above embodiments or in different embodiments are also possible within the framework of the embodiments of the present application, and many other variations of different aspects of the embodiments of the present application as described above are possible, which are not provided in detail for the sake of clarity. Therefore, any omission, modification, equivalent substitution, improvement, etc. made within the spirit and principles of the embodiments of the present application shall fall within the protection scope of the embodiments of the present application.

1. A method for processing a file read-write service, comprising:
in response to receiving a read-write service of a file, determining, based on a file serial number, whether a cache handle of the file is present in an index container;
in response to the cache handle of the file not being present in the index container, opening, based on the read-write service, a corresponding handle of the file;
encapsulating a flag and a pointer of the corresponding handle and the file serial number so as to obtain a cache handle of the file;
adding the cache handle of the file into the index container and a first queue;
processing the read-write service by using the corresponding handle of the file; and
in response to completion of processing the read-write service, moving the cache handle of the file from the first queue to a second queue.

2. The method as claimed in claim 1, the method further comprises:
detecting a usage time of each of cache handles in the second queue to determine whether the usage time exceeds a threshold;
in response to a presence of a cache handle with the usage time exceeding the threshold, removing the cache handle with the usage time exceeding the threshold from the second queue; and
removing a corresponding cache handle in the index container based on a file serial number in the cache handle with the usage time exceeding the threshold, and closing a corresponding handle based on a handle pointer.

3. The method as claimed in claim 1, the method further comprises:
in response to a quantity of cache handles in the second queue reaching a preset quantity, deleting a plurality of cache handles starting from a tail of the second queue; and
deleting corresponding cache handles in the index container based on file serial numbers in the plurality of cache handles respectively, and closing corresponding handles based on handle pointers.

4. The method as claimed in claim 1, the method further comprises:
in response to the cache handle of the file being present in the index container, determining whether a handle flag in the cache handle of the file corresponds to the read-write service; and
in response to the handle flag in the cache handle of the file corresponding to the read-write service and the cache handle of the file being in the second queue, moving the cache handle in the second queue to the first queue, and processing the read-write service by using an opened corresponding handle of the file.

5. The method as claimed in claim 4, the method further comprises:
in response to the handle flag in the cache handle of the file corresponding to the read-write service and the cache handle of the file being in the first queue, processing the read-write service by using the opened corresponding handle of the file, and updating a usage count of the cache handle of the file.

6. The method as claimed in claim 5, wherein moving the cache handle of the file from the first queue to the second queue further comprises:
determining whether the usage count of the cache handle of the file reaches a preset value;
in response to the usage count of the cache handle of the file reaching the preset value, moving the cache handle of the file to a head of the second queue; and
updating a usage time of the cache handle of the file.

7. The method as claimed in claim 4, the method further comprises:
in response to the handle flag in the cache handle of the file not corresponding to the read-write service and the cache handle of the file being in the second queue, deleting the cache handle of the file from the second queue and the index container, and closing the corresponding handle based on a handle pointer;
reopening the corresponding handle of the file based on the read-write service;
encapsulating the flag and the pointer of the corresponding handle and the file serial number so as to obtain a new cache handle of the file;
adding the new cache handle of the file into the index container and the first queue; and
processing the read-write service by using a reopened corresponding handle of the file.

8. (canceled)

9. A computer device, comprising:
at least a processor; and
a memory storing computer program capable of running on the processor that, when executed by the processor, cause the processor to:
in response to receiving a read-write service of a file, determine, based on a file serial number, whether a cache handle of the file is present in an index container;
in response to the cache handle of the file not being present in the index container, open, based on the read-write service, a corresponding handle of the file;
encapsulate a flag and a pointer of the corresponding handle and the file serial number so as to obtain a cache handle of the file;
add the cache handle of the file into the index container and a first queue;
process the read-write service by using the corresponding handle of the file; and
in response to completion of processing the read-write service, move the cache handle of the file from the first queue to a second queue.

10. A non-transitory computer-readable storage medium storing computer program that, when executed by a processor, cause the processor to
in response to receiving a read-write service of a file, determine, based on a file serial number, whether a cache handle of the file is present in an index container;
in response to the cache handle of the file not being present in the index container, open, based on the read-write service, a corresponding handle of the file;
encapsulate a flag and a pointer of the corresponding handle and the file serial number so as to obtain a cache handle of the file;
add the cache handle of the file into the index container and a first queue;
process the read-write service by using the corresponding handle of the file; and
in response to completion of processing the read-write service, move the cache handle of the file from the first queue to a second queue.

11. The method as claimed in claim 1, the method further comprises:
in response to that the cache handle is present in the first queue, determining the cache handle is being used to perform the read-write service, and in response to that the cache handle is present in the second queue, determining the cache handle is not used.

12. The method as claimed in claim 2, wherein the usage time is updated in response to the cache handle is moved from the first queue to the second queue.

13. The method as claimed in claim 1, wherein the cache handle is moved from the first queue to the second queue, the cache handle is placed at a head of the second queue.

14. The method as claimed in claim 5, the method further comprises:
in response to that another thread uses the opened corresponding handle of the file for the read-write service, the usage count of the cache handle of the file is increased, and in response to that the read-write service of a thread is completed, the usage count of the cache handle of the file is decreased.

15. The computer device as claimed in claim 9, the processor is further configured to:
detect a usage time of each of cache handles in the second queue to determine whether the usage time exceeds a threshold;
in response to a presence of a cache handle with the usage time exceeding the threshold, remove the cache handle with the usage time exceeding the threshold from the second queue; and
remove a corresponding cache handle in the index container based on a file serial number in the cache handle with the usage time exceeding the threshold, and close a corresponding handle based on a handle pointer.

16. The computer device as claimed in claim 9, the processor is further configured to:
in response to a quantity of cache handles in the second queue reaching a preset quantity, delete a plurality of cache handles starting from a tail of the second queue; and
delete corresponding cache handles in the index container based on file serial numbers in the plurality of cache handles respectively, and close corresponding handles based on handle pointers.

17. The computer device as claimed in claim 9, the processor is further configured to:
in response to the cache handle of the file being present in the index container, determine whether a handle flag in the cache handle of the file corresponds to the read-write service; and
in response to the handle flag in the cache handle of the file corresponding to the read-write service and the cache handle of the file being in the second queue, move the cache handle in the second queue to the first queue, and process the read-write service by using an opened corresponding handle of the file.

18. The computer device as claimed in claim 17, the processor is further configured to:
in response to the handle flag in the cache handle of the file corresponding to the read-write service and the cache handle of the file being in the first queue, process the read-write service by using the opened corresponding handle of the file, and update a usage count of the cache handle of the file.

19. The computer device as claimed in claim 18, the processor is further configured to:
determine whether the usage count of the cache handle of the file reaches a preset value;
in response to the usage count of the cache handle of the file reaching the preset value, move the cache handle of the file to a head of the second queue; and
update a usage time of the cache handle of the file.

20. The computer device as claimed in claim 17, the processor is further configured to:
in response to the handle flag in the cache handle of the file not corresponding to the read-write service and the cache handle of the file being in the second queue, delete the cache handle of the file from the second queue and the index container, and close the corresponding handle based on a handle pointer;
reopen the corresponding handle of the file based on the read-write service;
encapsulate the flag and the pointer of the corresponding handle and the file serial number so as to obtain a new cache handle of the file;
add the new cache handle of the file into the index container and the first queue; and
process the read-write service by using a reopened corresponding handle of the file.

21. The non-transitory computer-readable storage medium as claimed in claim 10, the processor is further configured to:
detect a usage time of each of cache handles in the second queue to determine whether the usage time exceeds a threshold;
in response to a presence of a cache handle with the usage time exceeding the threshold, remove the cache handle with the usage time exceeding the threshold from the second queue; and
remove a corresponding cache handle in the index container based on a file serial number in the cache handle with the usage time exceeding the threshold, and close a corresponding handle based on a handle pointer.
